(19) United States
(12) Patent Application Publication
(10) Pub. No.: US 2006/0140110 A1
(43) Pub. Date: Jun. 29, 2006

(54) Method and system for joint mode and guard interval detection

(75) Inventor: Che-Li Lin, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/336,101

(22) Filed: Jan. 19, 2006

Related U.S. Application Data
(63) Continuation-in-part of application No. 11/024,162, filed on Dec. 28, 2004.

(51) Int. Cl. H04J 11/00

(52) U.S. Cl. 370/208

(57) ABSTRACT

An exemplary embodiment provides a system for detecting guard interval size and mode of a broadcasting signal comprising m potential guard interval size varieties and n potential mode varieties, in which each potential mode defines an OFDM symbol period. A detection method implemented by the system is also provided. The system comprises an ADC, n mode detectors, and an arbitrator. The ADC samples the broadcasting signal to form a digital signal. Each mode detector is associated with a presuming mode and OFDM symbol period, synchronously receiving the digital signal from the ADC and performing detection processes based thereon, and n corresponding flags are generated to indicate the detection results. The arbitrator is coupled to the outputs of the mode detectors, observing the flags generated therefrom to determine the guard interval size and mode of the broadcasting signal. When the guard interval size and mode of the broadcasting signal are determined by one of the mode detectors, the arbitrator further terminates the operations of the other mode detectors.

### CROSS REFERENCE TO RELATED APPLICATIONS

This application is a Continuation-In-Part of pending U.S. patent application Ser. No. 11/024,162 filed Dec. 28, 2004 and entitled “method and system for Joint mode and guard interval detection”.

### BACKGROUND OF THE INVENTION

1. Field of the Invention

The invention relates to digital television (DTV) systems, more specifically to joint detection methods and systems for detecting mode and guard interval size in a received Orthogonal Frequency Division Multiplexing (OFDM) signal.

2. Description of the Related Art

Digital Video Broadcasting-Terrestrial (DVB-T) is a standard for wireless broadcast of video signals using OFDM with concatenated error coding. OFDM is a multi-carrier communication scheme for data transmission over multi-path channels. Information transmitted over different carriers can be properly separated, as the carriers of OFDM symbols are orthogonal to each other.

Inter-symbol interference (ISI) induced by multi-path channels can be minimized by including a cyclic prefix guard interval in each of the active OFDM symbols. The guard interval of a current active symbol is a tail portion of a previous symbol repeated before the current active symbol. Reflections of the previous symbol can be completely removed and the orthogonal feature can be preserved if the guard interval is longer than the maximum channel delay. The duration of the guard interval is flexible as the presence of the guard interval reduces the transmission channel efficiency. The size of the guard interval is thus selected in accordance with transmission quality and conditions so that a desired tradeoff between ISI mitigation capability and channel capacity can be obtained.

The DVB-T or Digital Video Broadcasting-Handheld (DVB-H) systems also support flexible modes of operation, which define different OFDM symbol sizes in order to provide adequate service quality under all kinds of channel conditions. Three modes provided in current DTV specifications are 2K mode, 4K mode, and 8K mode, and the OFDM symbol sizes are conjugator 2048, 4096, and 8192 respectively. The 2K mode is suitable for single transmitter operation and for small Single Frequency Networks (SFN) with limited transmitter distances. The 8K mode can be used in environments with long multi-path delay, and is suitable for both signal transmitter operation and SFN networks. The cell size accommodated by the 8K mode is thus bigger than the other two modes.

The mode of operation and the guard interval size of a DVB signal are unknown when the DVB signal is received by a DVB-T receiver. The DVB-T receiver thus requires a blind detection mechanism to determine the actual mode and the guard interval size in order to receive other system parameters for subsequent data receiving operations.

The DVB signal is organized in frames, each having 68 OFDM symbols. Each OFDM symbol comprises a useful part and a guard interval, and is constituted by a set of 6817 carriers in the 8K mode, 3409 carriers in the 4K mode, or 1705 carriers in the 2K mode. The unused carriers not carrying OFDM symbols are used as guard bands. There are four different guard interval sizes, N/32, N/16, N/8, and, N/4 that may be used for adapting to different transmission conditions, where N is the length of the useful part referred to as the OFDM symbol period, N=conjugator 2048 for the 2K mode, N=4096 for the 4K mode, and N=8192 for the 8K mode. There are four potential guard interval sizes and three potential modes that can be used to transmit a DVB signal. Thus, a DVB-T receiver must be capable of rapidly determining one of the 3*4=12 combinations while receiving the DVB signal.

### BRIEF SUMMARY OF INVENTION

A detailed description is given in the following embodiments with reference to the accompanying drawings.

An exemplary embodiment provides a system for detecting guard interval size and mode of a DVB signal comprising m potential guard interval size varieties and n potential mode varieties, in which each potential mode defines an OFDM symbol period. A detection method implemented by the system is also provided. The system comprises an ADC, n mode detectors, and an arbitrator. The ADC samples the DVB signal to form a digital signal. Each mode detector is corresponding to a presuming mode and OFDM symbol period, synchronously receiving the digital signal from the ADC and performing detection processes based thereon, and n corresponding flags are generated to indicate the detection results. The arbitrator is coupled to the outputs of the mode detectors, observing the flags generated therefrom to determine the guard interval size and mode of the DVB signal. When the guard interval size and mode of the DVB signal are determined by one of the mode detectors, the arbitrator further terminates the operations of the other mode detectors.

Each mode detector comprises a correlation integrator, a characteristic extractor and an analysis unit. The correlation integrator accumulates the digital signal in the corresponding presuming OFDM symbol period, and generates at least one moving sum from the accumulation according to one of the potential guard interval sizes. The characteristic extractor is coupled to the correlation integrator, rendering characteristics of the correlation signal with respect to a sample period W. The analysis unit is coupled to the characteristic extractor, observing the characteristics to generate a flag that comprising the detection results.

The correlation integrator may comprise a delay line, a conjugator, a multiplier, m correlators and m absolutizers. The delay line delays the digital signal by the corresponding presuming OFDM symbol period. The conjugator coupled to the delay line generates a conjugation of the delayed digital signal. The multiplier multiplies the digital signal with output from the conjugator to generate the preliminary correlation signal. The correlators are coupled to the multiplier, individually segmenting the preliminary correlation signal by m presuming guard interval sizes to generate m correlation signals correspondingly. Specifically, the correlation signals are respectively moving sums of the segmented preliminary correlation signals. The absolutizers, each coupled to a correlator, convert the m correlation signals from complex forms to absolute forms.

The characteristic extractor comprises m calculators each coupled to a corresponding absolutizer, individually determining m characteristic sets corresponding to the m correlation signals. Each characteristic set may comprise maximum values (N_{M}) and numbers of points above a threshold (N_{P}) within a sample period W. The calculator renders a metric curve representing absolute values of the corresponding correlation signal versus the sample period W, determines a peak of the metric curve as the N_{M}, provides a threshold line crossing the metric curve, whereby two crossing points are generated, and determines the length between the two crossing points as the N_{P}. Each characteristic set may further comprise a maximum value position N_{I}, indicating the timing point of the N_{M} in the sample period W. The calculator further locates the N_{I} corresponding to each presuming guard intervals.

The analysis unit comprises m dividers, a guard interval (GI) picker and a statistic unit. The dividers each coupled to a corresponding calculator, calculate and compare a ratio between the N_{M} and N_{P} corresponding to each correlation signal. The guard interval (GI) picker coupled to the m dividers, selects one of the presuming guard interval size having maximum N_{M}/N_{P} ratio among the m presuming guard interval sizes as a candidate guard interval size. The statistic unit coupled to the GI picker, examines the N_{I} of the candidate guard interval size. If the N_{I} occurs periodically, the statistic unit determines the candidate guard interval size as valid, otherwise invalid.

The statistic unit further recursively counts the validities and invalidities of the candidate guard interval size over a period of time. If the validities exceed a success threshold, the statistic unit outputs the flag indicating the validity of the candidate guard interval size. If the invalidities exceed a failure threshold, the statistic unit outputs the flag indicating the invalidity of the digital signal detection. The success and failure thresholds of a longer OFDM symbol period mode are set to be less than or equal to a shorter OFDM symbol period mode.

In an alternative embodiment, the correlation integrator requires only one correlator and one absolutizer. The correlator coupled to the multiplier segments the preliminary correlation signal by a presuming guard interval size to generate a correlation signal, and the absolutizer coupled to the correlator, converts the correlation signal from complex form to absolute form. The characteristic set may comprise a check point Nt within the sample period W. The calculator provides a threshold line crossing the metric curve, whereby two crossing points are generated, and determines the timing point of the first crossing points as the check point Nt. The analysis unit comprises a periodicity checker, coupled to the characteristic extractor and checking the periodicity of Nt. If the periodicity of Nt is subsequently a multiple of a combination (N+N_{GI}), the periodicity checker determines the guard interval size corresponding to the N_{GI} as valid, otherwise invalid. N is the mode dependent constant, and the N_{GI} is the guard interval size dependent constant selected from one of N/4, N/8, N/16 and N/32. The analysis unit further comprises a statistic unit, coupled to the periodicity checker, recursively counting the validities and invalidities of the periodicity of Nₜ over every combination of (N+N_{GI}) for a period of time.

### BRIEF DESCRIPTION OF DRAWINGS

The invention can be more fully understood by reading the subsequent detailed description and examples with references made to the accompanying drawings, wherein:

FIG. 1 illustrates an embodiment of a detection system for mode and guard interval size detection in DVB-T system;

FIGS. 2a and 2b illustrate an embodiment of the mode detector 140 according to FIG. 1;

FIG. 3 illustrates a metric curve crossing a threshold line;

FIG. 4 shows another embodiment of the mode detector 140 according to FIG. 1;

FIG. 5 shows exemplary correlation signals under two timing conditions;

FIG. 6 is a flowchart of validation check according to the maximum value positions;

FIG. 7 is a flowchart showing an embodiment of a confirmation block; and

FIG. 8 is a flowchart showing an embodiment of a mode information combine block.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

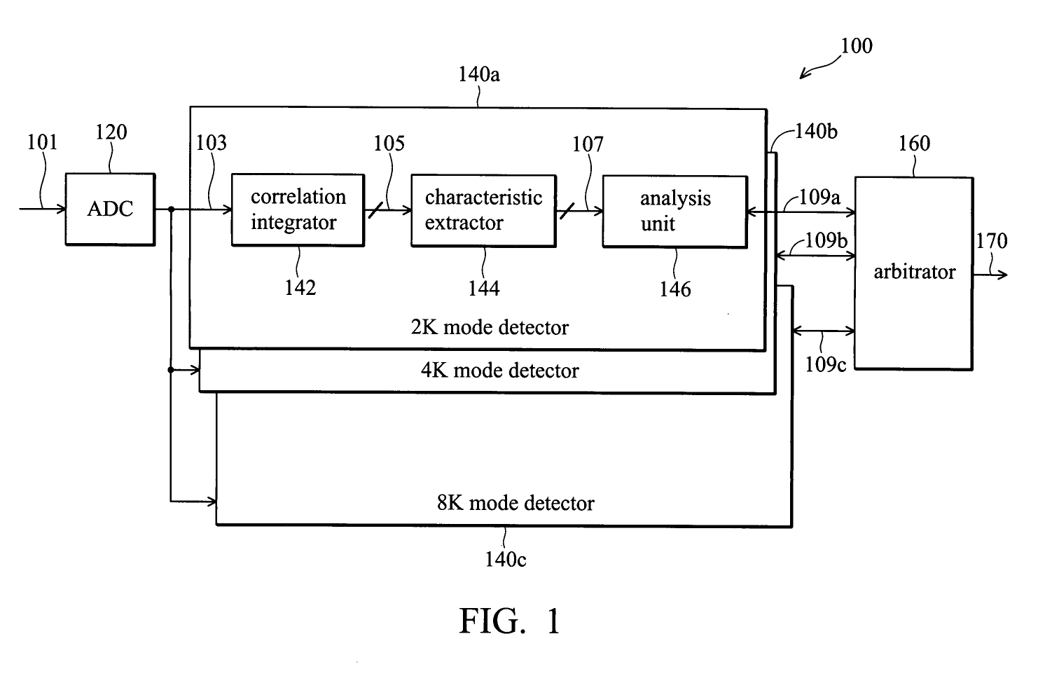

FIG. 1 shows an exemplary detection system 100 in a receiver for detecting guard interval size and mode of a DVB signal. The detection system 100 comprises an analog to digital converter (ADC) 120, three guard interval detection systems (mode detector) mode detector 140a to 140c, and an arbitrator 160. Each of the mode detectors 140a to 140c is specifically designed for guard interval size detection in different mode, synchronously tracking for an ultimate correct configuration of the DVB signal. For example, the first mode detector 140a performs a 2K mode detection, the second mode detector 140b a 4K mode detection, and the third mode detector 140c 8K mode. The ADC 120 converts a DVB signal 101 into a digital signal 103, and provides the digital signal 103 to each of the mode detectors 140a to 140c. The flags 109a to 109c corresponding to the mode detectors 140a to 140c are sent to the arbitrator 160. A DVB signal of a mode and a guard interval size, will be detected by a corresponding mode detector, and a flag is thus generated to indicate the validity of the mode and guard interval size. Since three mode detectors synchronously detect the digital signal 103, only one of the flags 109a to 109c comprises the valid result while others are invalid. The arbitrator 160 receives the flags 109a to 109c to determine the most possible mode and guard interval, and when the validity of the determination is further confirmed, the arbitrator 160 informs the mode detector to terminate the parallel search. In FIG. 1, each of the mode detectors 140a to 140c comprises a correlation integrator 142, a characteristic extractor 144, and an analysis unit 146. The correlation integrator 142 accumulates the digital signal in the corresponding presuming OFDM symbol period, and generating at least one moving sum from the accumulation according to one of the potential guard interval sizes. The characteristic extractor 144 coupled to the correlation integrator 142, renders characteristics of the correlation signal with respect to a sample period W. The analysis unit 146 coupled to the characteristic extractor 144, observes the characteristics to generate a flag that comprising the detection results.

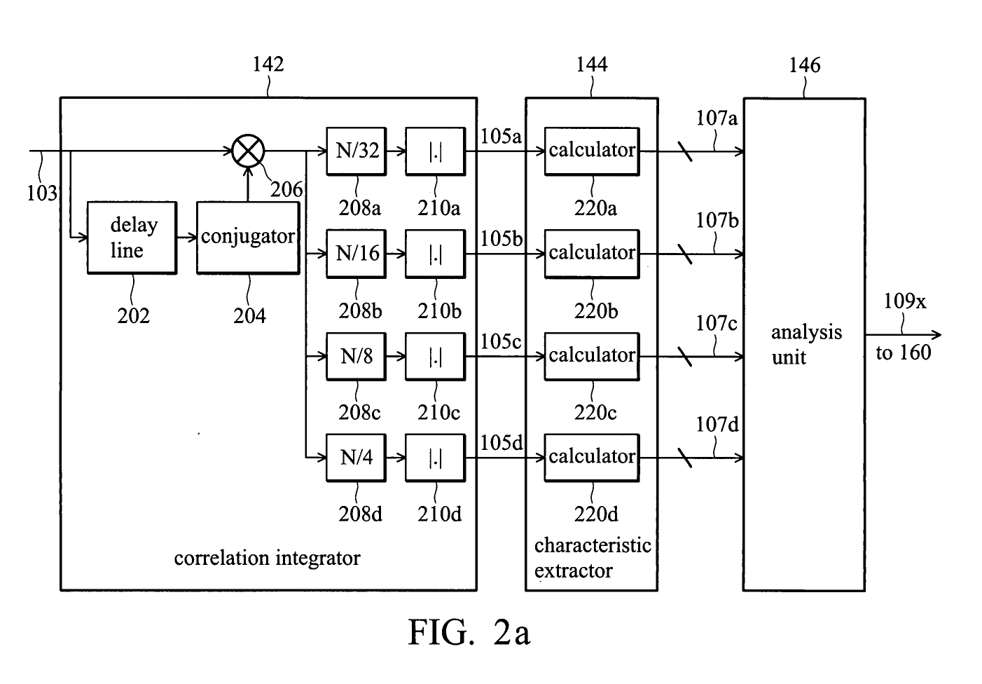

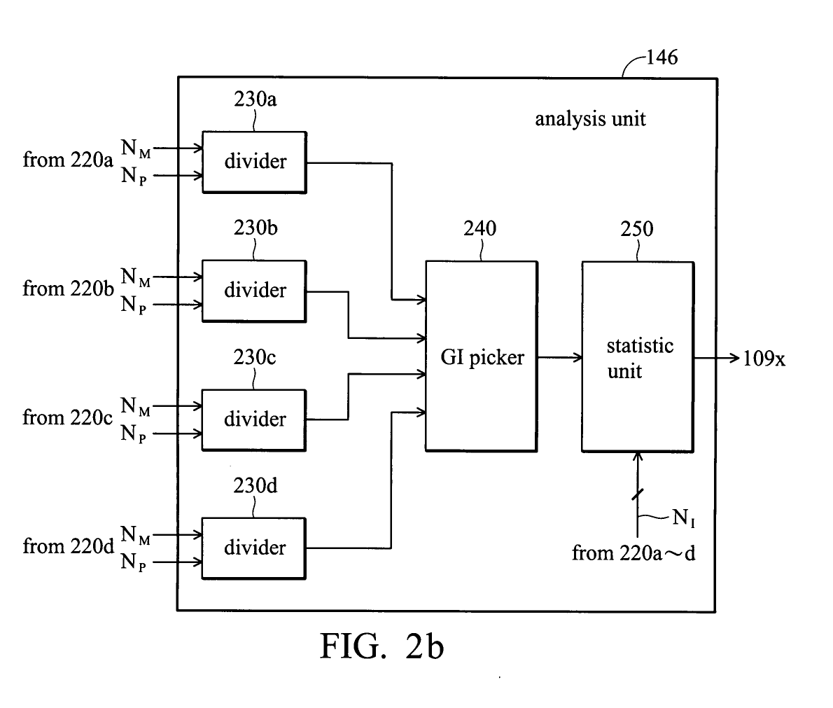

FIGS. 2a and 2b show specific embodiments of the correlation integrator 142, characteristic extractor 144 and analysis unit 146. As shown in FIG. 2a, the correlation integrator 142 computes a preliminary correlation signal by self-correlating the digital signal digital signal 103, and generates four correlation signals 105a to 105d corresponding to the four guard interval sizes (N/32, N/16, N/8, and, N/4 respectively). The correlation integrator 142 comprises a delay line 202, a conjugator 204, a multiplier 206, four moving sums 208 and four absolutizers 210. The delay line 202 delays the digital signal 103 by the corresponding presuming OFDM symbol period, for example, 2K, 4K or 8K symbol times corresponding to the mode. The digital signal 103 may be complex signals comprising inphase and quadrature components, and the delay line 202, conjugator 204 and multiplier 206 are designed to perform complex operations. The conjugator 204 coupled to the delay line 202, generates a conjugation of the delayed digital signal therefrom. The multiplier 206 then multiplies the digital signal 103 with the output of conjugator 204, and outputs a preliminary correlation signal as a result. The four moving sum 208 coupled to the multiplier 206, each relates to one of the guard interval sizes N/4, N/8, N/16 and N/32, individually segmenting the preliminary correlation signal by the guard interval sizes to generate four correlation signals. Specifically, the preliminary correlation signal is segmented and accumulated within a second delay line within the moving sum 208 having length of to the guard interval size. In the correlation integrator 142, the four absolutizer 210 each coupled to a moving sum 208, convert the four correlation signals from complex forms to absolute forms, and the correlation signals 105a to 105d are then output.

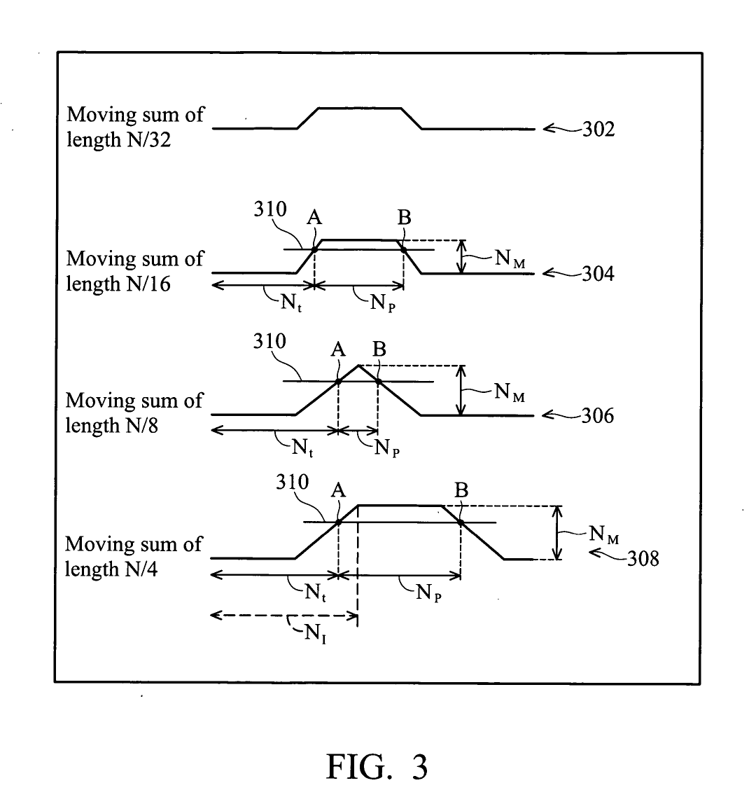

In FIG. 2a, the characteristic extractor 144 comprises four calculators 220 each coupled to a corresponding absolutizer 210, individually determining characteristic sets corresponding to the correlation signals. A characteristic set comprises maximum values (N_{M}), numbers of points above a threshold (N_{P}), and a maximum value position N_{I} indicating the timing point of the N_{M} within a sample period W. The sample period W is a windows size selected to be greater than N+N_{GI} for the characteristic analysis, where the N is the mode dependent symbol time varying from 2K, 4K to 8K, and the N_{GI} is the mode dependent guard interval size varying from N/4, N/8, N/16 to N/32. Thus, in practice for a safety boundary, the sample period W is typically selected to be no less than (N+N/4), for example, 1.5N. To determine the characteristic sets, each calculator 220 renders a metric curve representing absolute values of the corresponding correlation signal versus the sample period W. Referring to FIG. 3, a peak in the metric curve is chosen to be the N_{M}, and the timing point of the N_{M} to be the N_{I}. The calculator 220 also provides a threshold line 310 crossing the metric curve, whereby two crossing points are generated. The length between the two crossing points is the N_{P}. The characteristic sets comprising the N_{M}, N_{I}, and N_{P}, are then sent to analysis unit 146 for validation and confirmation.

FIG. 2b shows an embodiment of the analysis unit 146. The analysis unit 146 compares the N_{M} and N_{P} to detect which guard interval size is most matched, and double checks the validity of the detection according to the maximum value position N_{I}. The analysis unit 146 comprises four dividers 230, a guard interval (GI) picker 240 and a statistic unit 250. The dividers 230 are each coupled to a corresponding calculator 220 to calculate and compare a ratio between the N_{M} and N_{P} corresponding to each correlation signal. The GI picker 240, coupled to the dividers 230, selects one of the presuming guard interval sizes that has maximum N_{M}/N_{P} ratio among the m presuming guard interval sizes as a candidate guard interval size. The statistic unit 250, coupled to the GI picker 240, examines the N_{I} of the candidate guard interval size. If the N_{I} occurs periodically, the statistic unit 250 validates the candidate guard interval size, otherwise invalid. The statistic unit 250 further recursively charts the validities and invalidities of the candidate guard interval size over a period of time. If the validities exceed a success threshold, the statistic unit 250 outputs the flag indicating the validity of the candidate guard interval size, and if the invalidities exceed a failure threshold, the statistic unit 250 outputs the flag indicating the invalidity of the digital signal detection. In this way, a total of three flags 109a to 109c are respectively generated and sent to the arbitrator 160, and the arbitrator 160 detects which mode is most matched according thereto. For example, when a DVB signal is found to be valid in a 4K mode detector 140b with guard interval size N/16, a flag 109b may be delivered to the arbitrator 160 and deemed matched thereby. The arbitrator 160 then turns off the mode detector 140a and mode detector 140c (2K and 8K modes). The success threshold and the failure threshold of a longer OFDM symbol period mode are selected to be less than or equal to that of a shorter one.

FIG. 3 shows exemplary correlation signals generated from the correlation integrator 142. In FIG. 3, the actual guard interval size is N/8, which is unknown to the mode detector 140b. The metric curves 302, 304, 306 and 308 are the moving sums of the preliminary correlation signal with respect to the corresponding accumulated lengths N/32, N/16, N/8 and N/4. As a result, a sharp peak occurs in the metric curve 306, indicating a high correlation between the digital signal and the delayed digital signal. Conversely, the remaining metric curves 302, 304 and 308 do not appear to be valid, thus the guard interval size can be deemed to be N/8. The calculators 220a to 220d then receive the correlation signals to extract characteristics therefrom, such as maximum value N_{M}, maximum value position N_{I}, and a number of points above a threshold N_{P} of each symbol.

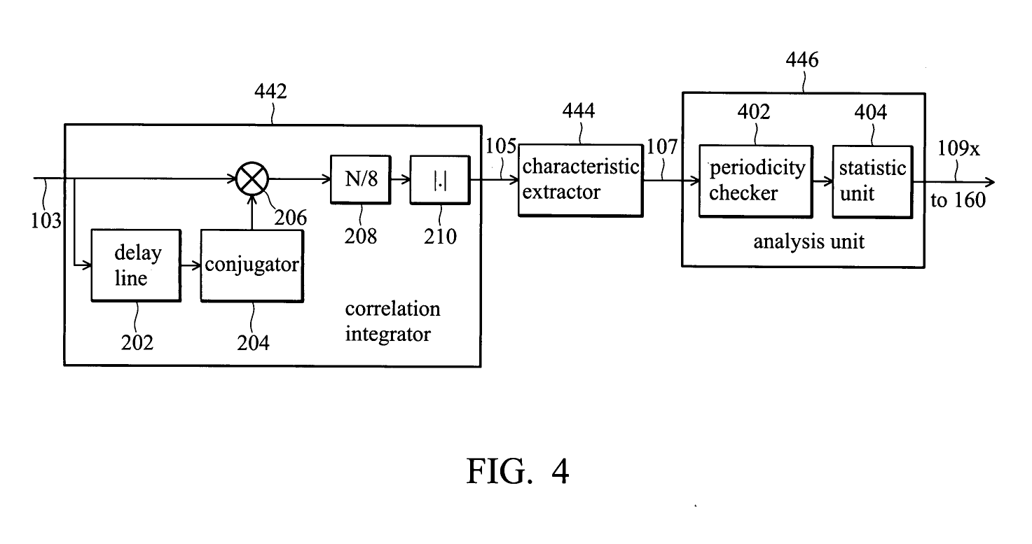

FIG. 4 shows an alternative embodiment of the mode detector 140, comprising a correlation integrator 442, a characteristic extractor 444 and an analysis unit 446. In the correlation integrator 442, only one moving sum 208 and absolutizer 210 are implemented while the correlation integrator 142 in FIG. 2a has four. The moving sum 208, coupled to the multiplier 206, segments the preliminary correlation signal by a presuming guard interval size to generate a correlation signal, where the presuming guard interval is preferably N/8 or N/16. The absolutizer 210 coupled to the moving sum 208 converts the correlation signal from a complex form to an absolute form. The characteristic extractor 444 extracts characteristics from the correlation signal 105 in a different way than the characteristic extractor 144 in FIG. 2a. The characteristic is defined to be a check point Nₜ within the sample period W. Referring to FIG. 3, the determination of the check point Nₜ is shown. The calculator 220 renders a metric curve 306 representing absolute values of the corresponding correlation signal versus the sample period W, and provides a threshold line 310 crossing the metric curve 306, whereby two crossing points A and B are generated. The timing point of the first crossing point A is deemed to be the check point Nₜ. The threshold line 310 is a horizontal line of a threshold value below the peak value of the metric curve. Specifically, the threshold value may be 0.7 times the maximum value.

The analysis unit 446 comprises a periodicity checker 402, coupled to the characteristic extractor 444 and checking the periodicity of Nₜ. If the periodicity of Nₜ is subsequently a multiple of a combination (N+N_{GI}), the periodicity checker 402 determines the guard interval size corresponding to the N_{GI} as valid, otherwise invalid, where N is the mode dependent constant varying from 2K, 4K to 8K, and the N_{GI} is the guard interval size dependent constant selected from N/4, N/8, N/16 or N/32. The analysis unit 446 also comprises a statistic unit 404, coupled to the periodicity checker 402, recursively counting the validities and invalidities of the periodicity of Nₜ over every combination of (N+N_{GI}) for a period of time. If the validities corresponding to one combination (N+N_{GI}) exceed a success threshold, the statistic unit 404 outputs the flag indicating the validity of the mode and guard interval size corresponding to the combination (N+N_{GI}). If the invalidities exceed a failure threshold, the statistic unit 404 outputs the flag indicating the invalidity of the detection.

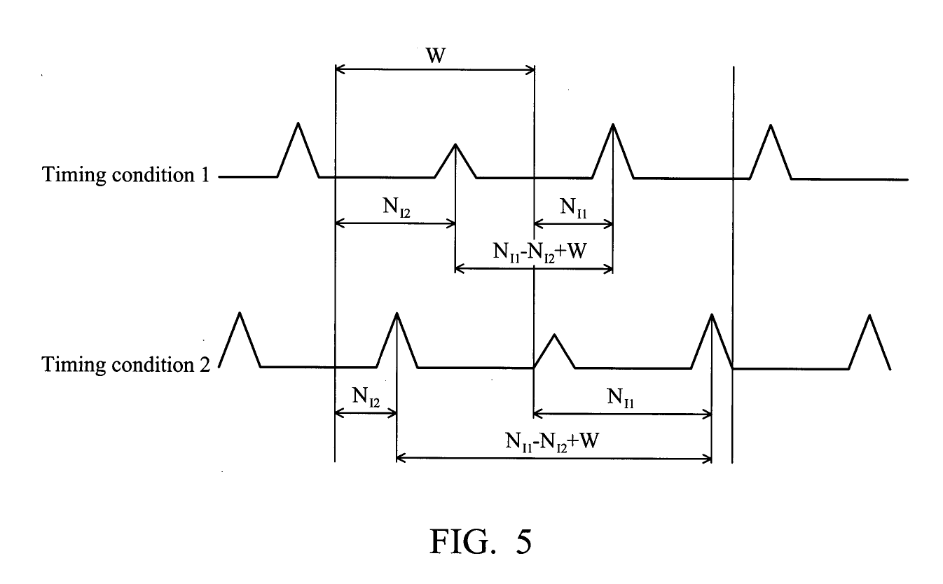

FIG. 5 shows exemplary correlation signals for depicting the two timing conditions. In timing condition 1, the distance between two consecutive maximum value positions N_{I1} and N_{I2} equals one symbol period (N+N_{GI}), that is,
N_{Il}−N_{I2}+W=N+N_{GI} (1)

Where N_{I1} and N_{I2} are the maximum value points detected in the calculator 220 of FIG. 2a. Additionally, the peak may be cut by the edge of the sampling window that is undetectable, therefore the N_{I} detected may belong to the next peak, as shown in the timing condition 2 of FIG. 5. As a result, the distance calculated by formula (1) is possibly twice the expected symbol period,
N_{I1}−N_{I2}+W=²(N+N_{GI}) (2)

Thus, both conditions are taken into consideration when examining the symbol period. In practice, formulas (1) and (2) are difficult to satisfy due to unavoidable errors. A predetermined tolerance value is provided for the validation. The predetermined tolerance value maybe mode dependent constant, denoted as E_{N}. The errors between the distance of two N_{I} and the symbol period are first calculated by the formulas:
Error1=Abs[N_{I1}−N_{I2}+W−(N+N_{GI})]; (3)
Error2=Abs[N_{I1}−N_{I2}+W−2(N +N_{GI})]; (4)

If Error1 or Error2 is below the predetermined tolerance value E_{N}, the symbol period N+N_{GI} is deemed valid for the input digital signal. Otherwise, if both error values exceed the predetermined tolerance value E_{N}, an invalid result is deemed.

Alternatively, in the case of the characteristic extractor 444 in FIG. 4 that determines validity by Nₜ, same concept can be applied to FIG. 5 by substituting N_{I} for the Nₜ. Thus, the symbol period determination can also be performed thereby.

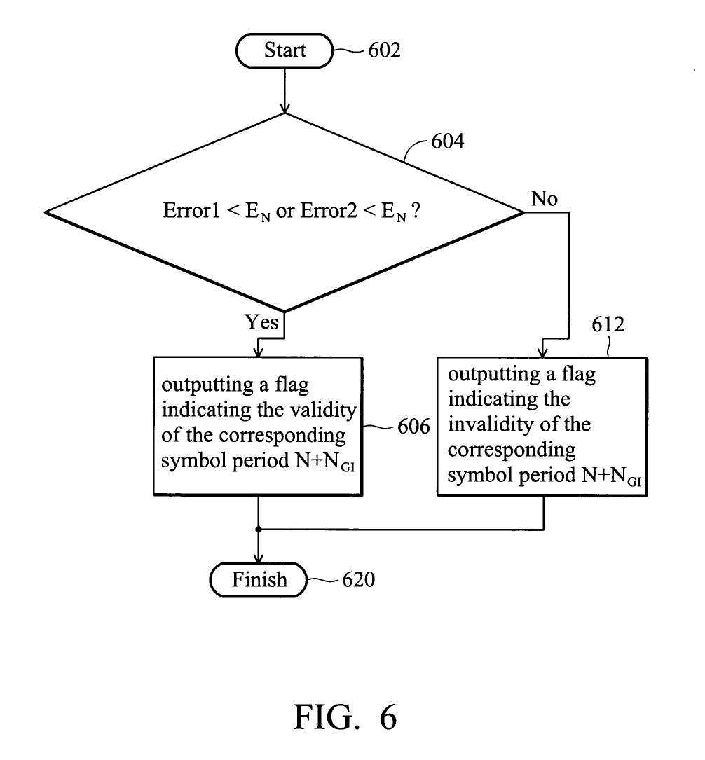

FIG. 6 is a flowchart of an exemplary validation check block examining whether a maximum value position N_{I} is periodical. The steps are typically processed in a recursive fashion since the symbol steam flows continuously. Step 602 initializes the validity determination. In step 604, the errors as expressed in formulas (3) and (4) are compared with a predetermined tolerance value E_{N}. If one of the errors is below the tolerance value E_{N}, step 606 is processed, outputting a flag indicating the validity of the corresponding symbol period N+N_{GI}. Conversely, if none of the errors satisfies the tolerance value limitation, step 612 is processed, outputting a flag indicating the invalidity of the corresponding symbol period N+N_{GI}. Step 620 concludes the process. This case utilizes N_{I} for the validation check, and an alternative embodiment may utilize Nₜ as denoted in FIG. 3 for the same process. In the Nₜ case, a total of potential combinations N+N_{GI} must be provided and compared by the periodicity checker 402 in FIG. 4. Specifically, the length between two Nₜ may be sequentially compared with (N+N/4), (N+N/8), (N+N/16), and (N+N/32) according to formulas (3) and (4) in the periodicity checker 402, whereas the correlation integrator 142 in FIG. 2a performs the N_{I} length comparison only for the candidate guard interval size (at a cost of more hardware such as the moving sum 208, absolutizers 210, calculators 220 and dividers 230).

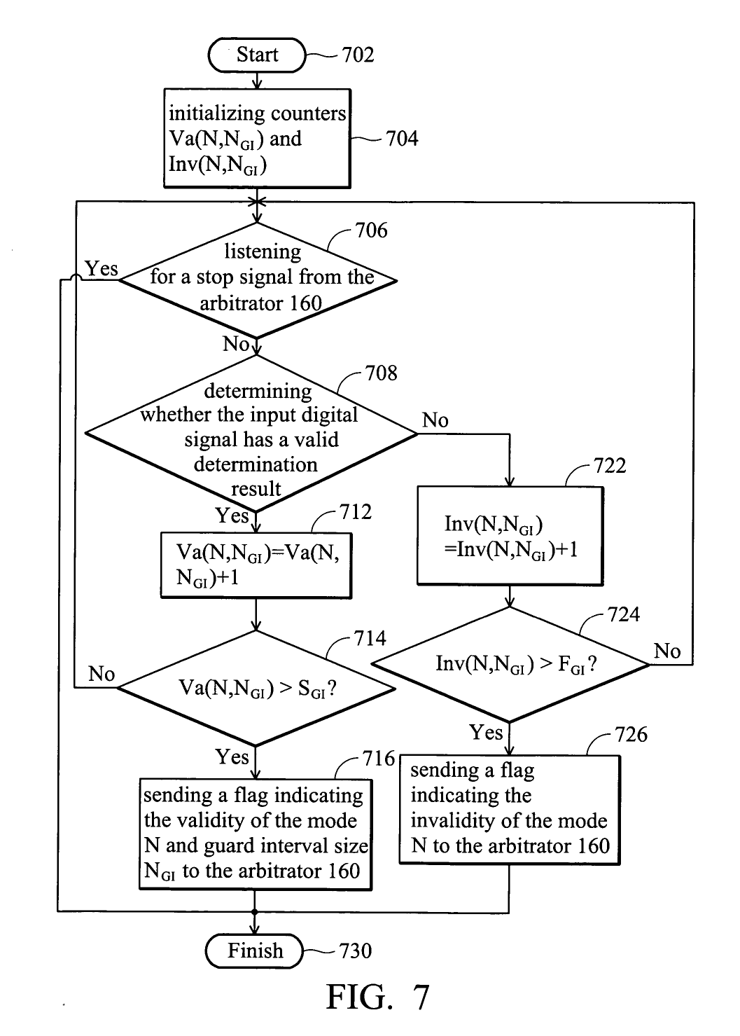

FIG. 7 is a flowchart illustrating execution of confirmation block procedures. The arbitrator 160 controls the mode detector 140 to either continue or terminate the detection based on flags delivered therefrom. In step 704, each mode detector 140 initializes four counter sets for each combination of the N+N_{GI}, comprising a valid counter Va(N,N_{GI}) and an invalid counter Inv(N,N_{GI}), where N is the mode detector 140 dependent value for each mode detector 140, and the N_{GI} are one of the N/4, N/8, N/16 and N/32. In step 706, the mode detector 140 awaits a stop signal from the arbitrator 160 that terminates the total operation upon the mode and guard interval size confirmation. If no stop signal is received, the process goes to step 708, determining whether the input digital signal has a valid determination result as described in FIG. 6. Yes to step 712, accumulating the corresponding valid counter Va(N,N_{GI}). Conversely, no to step 722, accumulates the corresponding invalid counter Inv(N,N_{GI}). A set of success and failure thresholds are provided. In step 714, the Va(N,N_{GI}) is compared with a success threshold S_{GI} of the corresponding guard interval size N_{GI}, and if the Va(N,N_{GI}) exceeds the success threshold S_{GI}, a flag indicating the validity of the mode N and guard interval size N_{GI} is sent to the arbitrator 160 in step 716, otherwise the process returns to step 706. Similarly in step 724, the Inv(N,N_{GI}) is compared with a failure threshold F_{GI} of the corresponding guard interval size N_{GI}, and if the Inv(N,N_{GI}) exceeds the failure threshold F_{GI}, a flag indicating the invalidity of the mode N is sent to the arbitrator 160 in step 726, otherwise the process returns to step 706. Step 730 concludes the process.

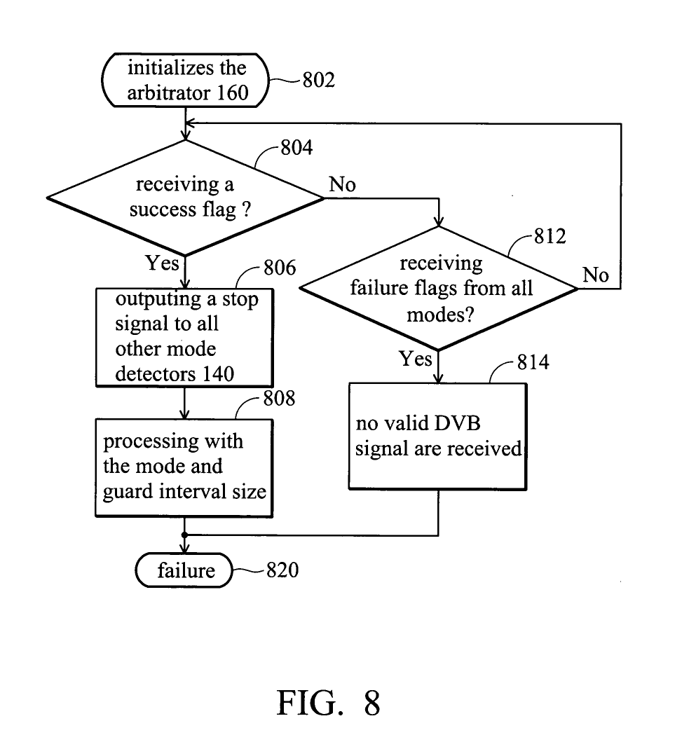

FIG. 8 is a flowchart showing procedures executed by an exemplary arbitrator 160. Step 802 initializes the arbitrator 160. In step 804, the arbitrator 160 awaits a flag delivered by the mode detector 140 indicating the validity of a mode and a guard interval size. If no success flag is received, in step 812, the arbitrator 160 checks whether all mode detectors 140 send flags indicating failure. If all flags sent from the mode detector 140 indicate failure, it is deemed that no valid DVB signals are received in step 814, and the process is concluded in step 820. In step 806, when a success flag is received in step 804, the arbitrator 160 outputs a stop signal to all other mode detectors 140. In step 808, the modules corresponding to the detected mode and guard interval size remain activated for further reception.

Rather than detecting the mode and guard interval size individually via a single mode detector, the embodiment described is more efficient based on parallelism. The mode detector requires only a small storage capacity, thus the memory consumed by the detection system with three mode detectors performing parallel search is still conservative in terms of memory usage.

The parameters of each statistic unit 404 and 250 can also be varied with different modes to improve system performance. For example, the predetermined tolerance value E_{N} for validation checking as shown in FIG. 5 corresponding to 8K mode can be set greater than that of a 4K or 2K mode. The success threshold and failure threshold shown in FIG. 8 correspond to 8K mode can be set to be smaller than that of a 4K or 2K mode.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for guard interval size and mode detection of a broadcasting signal, wherein the guard interval size comprises m potential varieties and the mode comprises n potential varieties, and the broadcasting signal has an OFDM symbol period varying with the mode, the method comprising:
sampling the broadcasting signal to form a digital signal;
substituting the digital signal into n synchronous detection processes each corresponding to a presuming mode and a presuming OFDM symbol period;
each detection process generating a flag indicating whether the corresponding substitution matches a predetermined requirement; and
observing the flags generated from the n detection processes to determine the guard interval size and mode of the broadcasting signal.

2. The method as claimed in claim 1, further comprising terminating the synchronous detection processes when the guard interval size and mode of the broadcasting signal are determined.

3. The method as claimed in claim 1, wherein each detection process comprises:
self segmenting and accumulating the digital signal by the corresponding presuming OFDM symbol period to generate a preliminary correlation signal;
individually segmenting the preliminary correlation signal by m presuming guard interval sizes to generate m correlation signals correspondingly, wherein the correlation signals are respectively moving sums of the segmented preliminary correlation signals;
determining m characteristic sets respectively for the m correlation signals; and
generating a flag statistically representing the validity of the substitution of the digital signal according to the m characteristic sets; wherein the m presuming guard interval sizes respectively identical to the m potential varieties.

4. The method as claimed in claim 3, wherein:
each characteristic set comprises maximum values (N_{M}) and numbers of points above a threshold (N_{P}) within a sample period W; and
the determination for each a characteristic set comprises:
rendering a metric curve representing absolute values of the corresponding correlation signal versus the sample period W;
deeming a peak of the metric curve as the N_{M};
providing a threshold line 310 crossing the metric curve, whereby two crossing points are generated; and
deeming the length between the two crossing points as the N_{P}.

5. The method as claimed in claim 4, wherein:
each characteristic set further comprises a maximum value position N_{I} indicating the timing point of the N_{M} in the sample period W; and
each detection process further comprises locating the N_{I} corresponding to each presuming guard intervals.

6. The method as claimed in claim 5, wherein each detection process further comprises:
calculating and comparing a ratio between the N_{M} and N_{P} corresponding to each correlation signal;
selecting one of the presuming guard interval size having maximum N_{M}/N_{P} ratio among the m presuming guard interval sizes as a candidate guard interval size;
examining the N_{I} of the candidate guard interval size; and
if the N_{I} occurs periodically, deeming the candidate guard interval size as valid, otherwise invalid.

7. The method as claimed in claim 6, wherein each detection process further comprises:
recursively counting the validities and invalidities of the candidate guard interval size over a period of time;
if the validities exceed a success threshold, outputting a flag indicating the validity of the candidate guard interval size; and
if the invalidities exceed a failure threshold, outputting the flag indicating the invalidity of the digital signal detection.

8. The method as claimed in claim 7, wherein:
the success threshold of a longer OFDM symbol period mode is set to be less than or equal to a shorter OFDM symbol period mode; and
the failure threshold of a longer OFDM symbol period mode is set to be less than or equal to a shorter OFDM symbol period mode.

9. The method according to claim 4, wherein the sample period W corresponding to each mode exceeds 1.25 times the OFDM symbol period N defined by the mode (W>1.25N).

10. The method as claimed in claim 1, wherein each detection process comprises:
generating a preliminary correlation signal representing a self accumulation of the digital signal within the presuming OFDM symbol period;
segmenting the preliminary correlation signal by a presuming guard interval size to generate a correlation signal, wherein the correlation signal is the moving sum of the segmented preliminary correlation signal;
determining a characteristic set for the correlation signal; and
generating a flag statistically representing the validity of the substitution of the digital signal according to the characteristic sets; wherein the presuming guard interval size is selected from one of the m potential varieties.

11. The method as claimed in claim 10, wherein:
The characteristic set comprises a check point Nₜ within a sample period W; and
the determination for the characteristic sets comprises:
rendering a metric curve representing absolute values of the corresponding correlation signal versus the sample period W;
providing a threshold line 310 crossing the metric curve, whereby two crossing points are generated; and
deeming the timing point of the first crossing points as the check point Nₜ.

12. The method as claimed in claim 11, wherein each detection process further comprises:
checking the periodicity of Nₜ; and
if the periodicity of Nₜ is subsequently a multiple of a combination (N+N_{GI}), deeming the guard interval size corresponding to the N_{GI} as valid, otherwise invalid; wherein:
N is the mode dependent constant, and the N_{GI} is the guard interval size dependent constant selected from one of N/4, N/8, N/16 and N/32.

13. The method as claimed in claim 12, wherein each detection process further comprises:
recursively counting the validities and invalidities of the periodicity of Nₜ over every combination of (N+N_{GI}) for a period of time;
if the validities corresponding to one combination (N+N_{GI}) exceed a success threshold, outputting a flag indicating the validity of the mode and guard interval size corresponding to the combination (N+N_{GI}); and
if the invalidities exceed a failure threshold, outputting the flag indicating the invalidity of the detection.

14. The method according to claim 13, wherein:
the success threshold of a longer OFDM symbol period mode is set to be less than or equal to a shorter OFDM symbol period mode; and
the failure threshold of a longer OFDM symbol period mode is set to be less than or equal to a shorter OFDM symbol period mode.

15. The method according to claim 11, wherein the sample period W corresponding to each mode exceeds 1.25 times the OFDM symbol period N defined by the mode (W>1.25N).

16. A system for detecting guard interval size and mode of a broadcasting signal comprising m potential guard interval size varieties and n potential mode varieties, wherein each potential mode defines an OFDM symbol period, comprising:
an analog-to-digital converter (ADC), sampling the broadcasting signal to form a digital signal;
n mode detectors, each corresponding to a presuming mode and OFDM symbol period, synchronously receiving the digital signal from the ADC and performing detection processes based thereon, such that n corresponding flags are generated to indicate the detection results; and
an arbitrator, coupled to the outputs of the mode detectors, observing the flags generated therefrom to determine the guard interval size and mode of the broadcasting signal.

17. The system as claimed in claim 16, wherein when the guard interval size and mode of the broadcasting signal are determined by one of the mode detectors, the arbitrator further terminates the operations of the other mode detectors.

18. The system as claimed in claim 16, wherein each mode detector comprises:
a correlation integrator, accumulating the digital signal in the corresponding presuming OFDM symbol period, and generating at least one moving sum from the accumulation according to one of the potential guard interval sizes;
a characteristic extractor, coupled to the correlation integrator, rendering characteristics of the correlation signal with respect to a sample period W; and
an analysis unit, coupled to the characteristic extractor, observing the characteristics to generate a flag comprising the detection results.

19. The system as claimed in claim 18, wherein the correlation integrator comprises:
a delay line, delaying the digital signal by the corresponding presuming OFDM symbol period;
a conjugator, coupled to the delay line, generating a conjugation of the delayed digital signal;
a multiplier, multiplying the digital signal with output from the conjugator to generate the preliminary correlation signal;
m correlators, coupled to the multiplier, individually segmenting the preliminary correlation signal by m presuming guard interval sizes to generate m correlation signals correspondingly, wherein the correlation signals are respectively moving sums of the segmented preliminary correlation signals; and
m absolutizers, each coupled to a correlator, converting the m correlation signals from complex forms to absolute forms.

20. The system as claimed in claim 19, wherein the characteristic extractor 144 comprises m calculators each coupled to a corresponding absolutizer, individually determining m characteristic sets corresponding to the m correlation signals; wherein:
each characteristic set comprises maximum values (N_{M}) and numbers of points above a threshold (N_{P}) within a sample period W; and
the calculator renders a metric curve representing absolute values of the corresponding correlation signal versus the sample period W;
the calculator determines a peak of the metric curve as the N_{M};
the calculator provides a threshold line 310 crossing the metric curve, whereby two crossing points are generated; and
the calculator determines the length between the two crossing points as the N_{P}.

21. The system as claimed in claim 20, wherein:
each characteristic set further comprises a maximum value position N_{I} indicating the timing point of the N_{M} in the sample period W; and
the calculator further locates the N_{I} corresponding to each presuming guard intervals.

22. The system as claimed in claim 21, wherein the analysis unit comprises:
m dividers, each coupled to a corresponding calculator, calculating and comparing a ratio between the N_{M} and N_{P} corresponding to each correlation signal;
a guard interval (GI) picker, coupled to the m dividers, selecting one of the presuming guard interval size having maximum N_{M}/N_{P} ratio among the m presuming guard interval sizes as a candidate guard interval size; and
a statistic unit, coupled to the GI picker, examining the N_{I} of the candidate guard interval size; wherein if the N_{I} occurs periodically, the statistic unit determines the candidate guard interval size as valid, otherwise invalid.

23. The system as claimed in claim 22, wherein:
the statistic unit further recursively counts the validities and invalidities of the candidate guard interval size over a period of time;
if the validities exceed a success threshold, the statistic unit outputs a flag indicating the validity of the candidate guard interval size; and
if the invalidities exceed a failure threshold, the statistic unit outputs the flag indicating the invalidity of the digital signal detection.

24. The system as claimed in claim 23, wherein:
the success threshold of a longer OFDM symbol period mode is set to be less than or equal to a shorter OFDM symbol period mode; and
the failure threshold of a longer OFDM symbol period mode is set to be less than or equal to a shorter OFDM symbol period mode.

25. The system as claimed in claim 18, wherein the correlation integrator comprises:
a delay line, delaying the digital signal by the corresponding presuming OFDM symbol period;
a conjugator, coupled to the delay line, generating a conjugation of the delayed digital signal;
a multiplier, multiplying the digital signal with the delayed digital signal to generate the preliminary correlation signal;
a correlator, coupled to the multiplier, segmenting the preliminary correlation signal by a presuming guard interval size to generate a correlation signal; and
an absolutizer, coupled to the correlator, converting the correlation signal from complex form to absolute form.

26. The system as claimed in claim 25, wherein the characteristic extractor determines a characteristic set corresponding to the correlation signals; wherein:
the characteristic set comprises a check point Nₜ within the sample period W; and
the calculator renders a metric curve representing absolute values of the corresponding correlation signal versus the sample period W;
the calculator provides a threshold line 310 crossing the metric curve, whereby two crossing points are generated; and
the calculator determines the timing point of the first crossing points as the check point Nₜ.

27. The system as claimed in claim 26, wherein the analysis unit comprises a periodicity checker, coupled to the characteristic extractor and checking the periodicity of Nₜ; wherein:
if the periodicity of Nₜ is subsequently a multiple of a combination (N+N_{GI}), the periodicity checker determines the guard interval size corresponding to the N_{GI} as valid, otherwise invalid; and
N is the mode dependent constant, and the N_{GI} is the guard interval size dependent constant selected from one of N/4, N/8, N/16 and N/32.

28. The system as claimed in claim 27, wherein the analysis unit further comprises a statistic unit, coupled to the periodicity checker, recursively counting the validities and invalidities of the periodicity of Nₜ over every combination of (N+N_{GI}) for a period of time; wherein:
if the validities corresponding to one combination (N+N_{GI}) exceed a success threshold, outputting the flag indicating the validity of the mode and guard interval size corresponding to the combination (N+N_{GI}); and
if the invalidities exceed a failure threshold, outputting the flag indicating the invalidity of the detection.

29. The system as claimed in claim 28, wherein:
the success threshold of a longer OFDM symbol period mode is set to be less than or equal to a shorter OFDM symbol period mode; and
the failure threshold of a longer OFDM symbol period mode is set to be less than or equal to a shorter OFDM symbol period mode.

30. The system as claimed in claim 18, wherein the sample period W corresponding to each mode exceeds 1.25 times the OFDM symbol period N defined by the mode (W>1.25N).
